(19) United States
(12) Patent Application Publication
(10) Pub. No.: US 2018/0006699 A1
(43) Pub. Date: Jan. 4, 2018

(54) Efficient Multi-Rank CSI Feedback Signaling

(71) Applicant: Nokia Solutions and Networks Oy, Espoo (FI)

(72) Inventors: Mihai ENESCU, Espoo (FI); Karol SCHOBER, Helsinki (FI)

(21) Appl. No.: 15/540,602

(22) PCT Filed: Dec. 23, 2015
(86) PCT No.: PCT/EP2015/081108

§ 371 Date: Jun. 29, 2017

Related U.S. Application Data
(60) Provisional application No. 62/097,737, filed on Dec. 30, 2014.

(51) Int. Cl. H04B 7/06; H04L 1/00

(52) U.S. Cl. CPC H04B 7/0626; H04B 7/0632; H04L 1/0026

(57) ABSTRACT

At a UE, a rank indication is determined for multi-rank CSI feedback for a subband. The UE selects one of multiple combinations of first and second offset levels for the subband to indicate the determined rank indication. Each offset level is for one of two different codewords and denotes an offset between an MCS class reported in a subband CQI and an MCS class in a wideband CQI. The UE transmits one or more indications of the first and second offset levels. A base station receives the one or more indications, and determines the rank indication based on the one or more indications of the first and second offset levels. The base station schedules, based on the determined rank indication, data for transmission to the user equipment using one or multiple ranks.

### TECHNICAL FIELD

This invention relates generally to wireless communications and, more specifically, relates to CSI (channel state information) feedback signaling.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section. Abbreviations that may be found in the specification and/or the drawing figures are defined below.

Multiple antenna techniques have become more prevalent as a way to increase throughput from a base station to a user equipment. Such multiple antenna techniques include single user MIMO (SU-MIMO) and multiple user MIMO (MU-MIMO). A good overview of multi-antenna techniques is provided in Gesbert et al., Chapter 11, “Multiple Antenna Techniques”, of “LTE: The UMTS Long Term Evolution, From Theory to Practice”, Sesia et al., editors, 2009. A few definitions are provided here as an introduction. The following terms are defined in the above-referenced book at page 261. The rank of a transmission is the number of layers transmitted from a transmitter to a receiver. A spatial layer is the term used in LTE for the different streams generated by spatial multiplexing. A layer can be described as a mapping of symbols onto the transmit antenna ports. A codeword is an independently encoded data block, corresponding to a single TB delivered from the MAC layer in the transmitter to the physical layer, and protected with a CRC. These terms are used below.

A MU-IC study item will try to identify possible multi-user (MU)-MIMO enhancements under assumption of a non-linear receiver at the UE. In fact, the MU-MIMO aspect has been under discussion for a while. For instance, previously with reference to Release 12, 3GPP agreed on two main enhancements. These enhancements included a double codebook for 4Tx antennas and feedback mode 3-2, which provides PMI and CQI per subband over PUSCH.

In order to enable efficient multi-rank operation of SU and MU-MIMO transmission, signaling of multi-rank CSI feedback can be performed to the eNB. Such signaling is applicable in any situation where the eNB desires to have multi-rank feedback. It is desirable to perform such signaling in an efficient manner in order to save at least uplink overhead.

### BRIEF SUMMARY

This section is intended to include examples and is not intended to be limiting.

In an exemplary embodiment, a method comprises: determining, at a user equipment, a rank indication for multi-rank CSI feedback for a subband; selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and transmitting by the user equipment one or more indications of the first and second offset levels.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: determining, at a user equipment, a rank indication for multi-rank CSI feedback for a subband; selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and transmitting by the user equipment one or more indications of the first and second offset levels.

An exemplary computer program product includes a computer-readable storage medium bearing computer program code embodied therein for use with a computer. The computer program code includes: code for determining, at a user equipment, a rank indication for multi-rank CSI feedback for a subband; code for selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and code for transmitting by the user equipment one or more indications of the first and second offset levels.

In another exemplary embodiment, an apparatus comprises: means for determining, at a user equipment, a rank indication for multi-rank CSI feedback for a subband; means for selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and means for transmitting by the user equipment one or more indications of the first and second offset levels.

In another exemplary embodiment, a method comprises: receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; determining, by the base station, the rank indication based on the one or more indications of the first and second offset levels; and scheduling, based on the determined rank indication and by the base station, data for transmission to the user equipment using one or multiple ranks.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; determining, by the base station, the rank indication based on the one or more indications of the first and second offset levels; and scheduling, based on the determined rank indication and by the base station, data for transmission to the user equipment using one or multiple ranks.

An exemplary computer program product includes a computer-readable storage medium bearing computer program code embodied therein for use with a computer. The computer program code includes: code for receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; code for determining, by the base station, the rank indication based on the one or more indications of the first and second offset levels; and code for scheduling, based on the determined rank indication and by the base station, data for transmission to the user equipment using one or multiple ranks.

In another exemplary embodiment, an apparatus comprises: means for receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; means for determining, by the base station, the rank indication based on the one or more indications of the first and second offset levels; and means for scheduling, based on the determined rank indication and by the base station, data for transmission to the user equipment using one or multiple ranks.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of an exemplary system in which the exemplary embodiments may be practiced;

FIG. 2 illustrates SU/MU multi-rank operation for a single UE in a single subframe;

FIG. 3 is Table 5.2.2.6.3-3 from 3GPP TS 36.212 V12.2.0 (2014-09);

FIG. 4 is a configuration table for the CSI process, enabling rank restricted feedback over codebook subset restriction;

FIG. 5 is a table for 3GPP LTE differential CQI table 7.2.1-2 in 3GPP TS 36.213;

FIG. 6 is a table with proposed modifications of differential CQI table in Table 1, in accordance with an exemplary embodiment;

FIG. 7 is a table illustrating joint coding of rank-1 and rank-2 ACQI offsets;

FIG. 8 is a logic flow diagram for efficient multi-rank CSI feedback signaling, and illustrates the operation of an exemplary method, a result of execution of computer program instructions embodied on a computer readable memory, functions performed by logic implemented in hardware, and/or interconnected means for performing functions in accordance with exemplary embodiments; and

FIGS. 9 and 10 are logic flow diagrams for efficient multi-rank CSI feedback signaling for a user equipment and a base station, respectively, and illustrate the operation of an exemplary method, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for efficient multi-rank CSI feedback signaling. Additional description of these techniques is presented after a system is described into which the exemplary embodiments may be used.

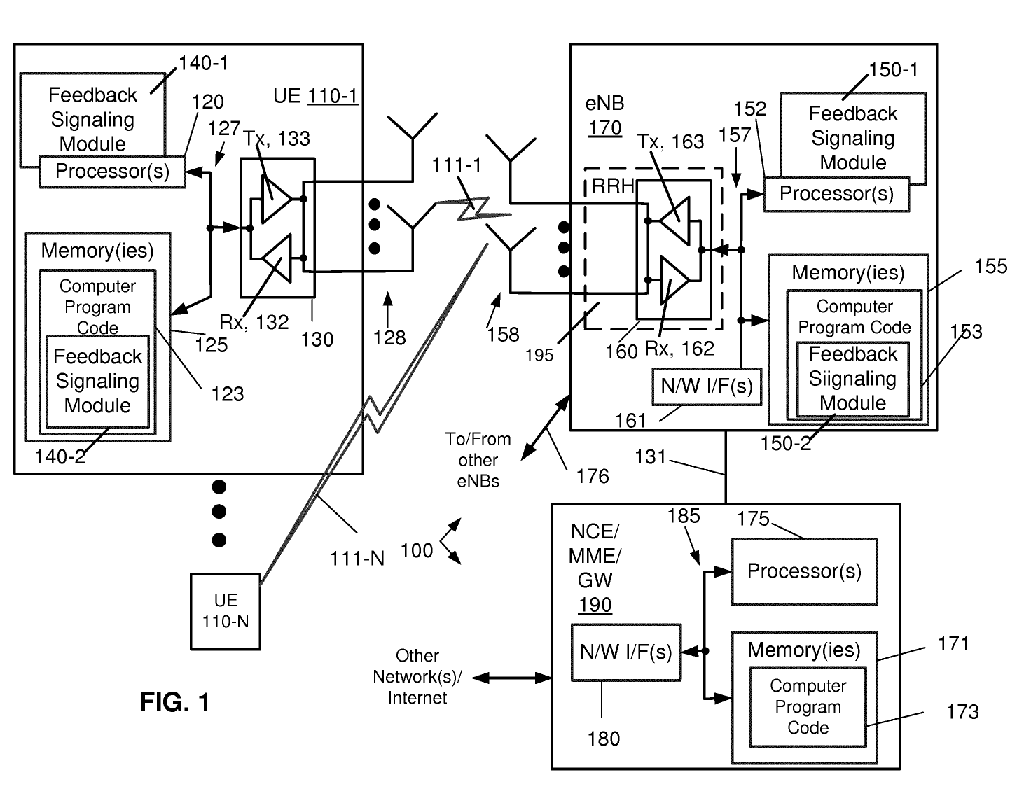

Turning to FIG. 1, this figure shows a block diagram of an exemplary system in which the exemplary embodiments may be practiced. In FIG. 1, multiple UEs 110-1 through 110-N are in wireless communication with a wireless network 100. In this disclosure, the term “user equipment” can be singular or plural, depending on the meaning. The UEs 110-1 through 110-N communicate with the wireless network 100 using corresponding wireless links 111-1 through 111-N, respectively, which can implement, e.g., a Uu interface. The UEs 110 are assumed to be similar, and only exemplary internal details of the UE 110-1 will be described herein. Note that a single UE will be referred to as UE 110.

The user equipment 110-1 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110-1 includes a feedback signaling module 140, comprising one of or both of parts 140-1 and/or 140-2, which may be implemented in a number of ways. The feedback signaling module 140 may be implemented in hardware as feedback signaling module 140-1, such as being implemented as part of the one or more processors 120. The feedback signaling module 140-1 may be implemented also as an integrated circuit or through other hardware such as a programmable gate array. In another example, the feedback signaling module 140 may be implemented as feedback signaling module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. A UE 110 communicates with eNB 170 via a wireless link 111.

The eNB 170 is a base station that provides access by wireless devices such as the UEs 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a feedback signaling module 150, comprising one of or both parts 150-1 and/or 150-2, which may be implemented in a number of ways. The feedback signaling module 150 may be implemented in hardware as feedback signaling module 150-1, such as being implemented as part of the one or more processors 152. The feedback signaling module 150-1 may be implemented also as an integrated circuit or through other hardware such as a programmable gate array. In another example, the feedback signaling module 150 may be implemented as feedback signaling module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

The exemplary embodiments herein consider a CSI feedback enhancement which enables efficient signaling of multi-rank CSI feedback to the eNB. Such signaling is applicable in any situation where the eNB desires to have multi-rank feedback.

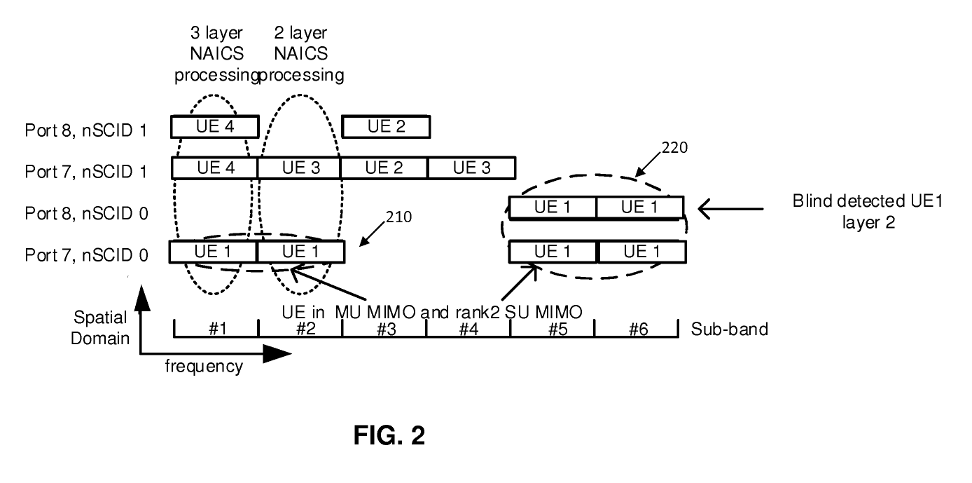

For example, if the eNB 170 is intending to schedule the users (e.g., UEs 110) in SU- and MU-MIMO in a dynamic way, hence per TTI/subframe, the multi-rank feedback is a necessity. In another example, such enhanced CSI feedback reporting can enable scheduling a single UE with different ranks in the same time-frequency subframe. FIG. 2 illustrates an example where a single UE 110 (referred to as UE1 in FIG. 2) can be scheduled in rank-1 in MU-MIMO (subbands #1, #2). This figure shows the spatial domain on the vertical axis and the frequency domain (in terms of six subbands) on the horizontal axis. Scheduling in rank-1 in MU-MIMO is illustrated by reference 210. Three (3) layer NAICS processing is performed in subband #1 (for UEs 1 and 4), while two (2) layer NAICS processing is performed in subband #2 (for UEs 1 and 3). By NAICS processing we mean the interference cancellation and/or suppression operation performed by the UE based on network assistance with respect to selected interference parameters and UE-based blind detection of interference structure. Meanwhile, in the other part of the frequency band (subbands #5, #6), where rank-2 transmission is more beneficial, UE1 is scheduled with rank-2 in SU-MIMO. This is illustrated by reference 220. nSCID is a scrambling identity, and the figure indicates that the UE1 detects via blind detection the layer 2 information. Two layers means that two codewords (only in rank-2) are transmitted to the UE, but each layer/codeword has different allocation.

One problem that may be solved is how to efficiently (e.g., with low overhead) report frequency selective CSI (e.g., rank, PMI, CQI) feedback, while minimizing the impact on a standard, i.e., minimizing standardization and implementation effort. First, the current CSI feedback reporting is described, then exemplary embodiments will be described.

The current CSI feedback reporting can be performed in several ways, described as follows.

1. One technique to perform reporting includes feedback based on best UE conditions. In this situation, the UE is computing CSI feedback (hence also rank) on the assumption that the UE 110 is maximizing the throughput. Thus, the UE 110 indicates to the eNB 170 the channel conditions used for best DL transmission. This feedback report considers wideband rank reporting. If the UE reports rank-2, such feedback is also usable by the eNB for scheduling either rank-1 or rank-2. This would not, however, provide the full information the UE has on the channel, as obviously the rank may be in practice frequency selective but such reporting is not possible in this situation.

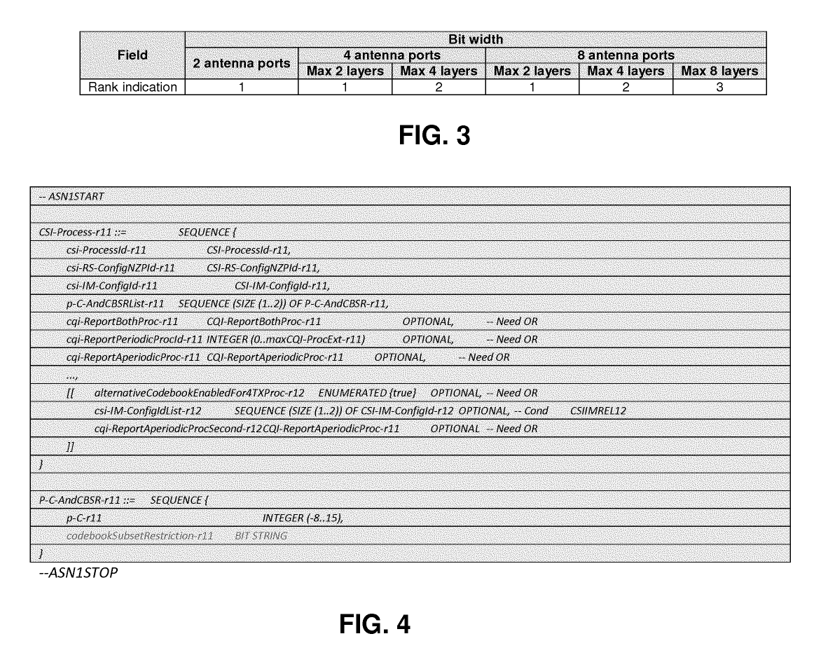

Such feedback results in one CSI feedback report but this feedback does not provide scheduling flexibility in terms of SU/MU dynamic switching. FIG. 3 shows Table 5.2.2.6.3-3 from 3GPP TS 36.212 V12.2.0 (2014-09). This table has fields for rank indication feedback for UE selected subband CQI reports (transmission mode 3, transmission mode 4, transmission mode 8 configured with PMI/RI reporting, transmission mode 9 configured with PMI/RI reporting with 2/4/8 antenna ports, and transmission mode 10 configured with PMI/RI reporting with 2/4/8 antenna ports). This table shows that rank is currently reported wideband, i.e., feedback does not depend on number of subbands.

2. A second technique to perform reporting involves feedback based on forced rank. The eNB 170 can trigger separate, per rank reporting. Making use of the codebook subset restriction together with two CSI processes, the eNB 170 can request CSI feedback characterizing each rank. As in the previous case, the rank is reported wideband, hence the rank suffers from the same limitation as described above. On the other hand, having both rank-1 and rank-2 CSI feedback available at the transmitter, the eNB 170 can better determine the usability of SU/MU scheduling per TTI, or can even enable the frequency selective rank scheduling for the same UE 110. However, this comes at the cost of doubling the UL feedback overhead. Additionally, note that eNB 175 can decide between rank-1 and rank-2 only based on quantized CSI (e.g., CQI), while the UE 110 may select preferred rank based on unquantized CSI. The text part in FIG. 4 shows that CSI-process-r11 is configured with codebook subset restriction, allowing for rank-restricted feedback. This is illustrated by “codebookSubsetRestriction-r11 BIT STRING”. Such feedback provides the eNB 175 the limited flexibility for SU/MU dynamic scheduling, but doubles the UL feedback overhead.

3. A third technique to perform reporting involves frequency-selective rank. The UE 110 can provide the CSI feedback based on frequency-selective rank. This would capture the channel conditions as seen by the UE and also maximize the throughput. However, such reporting does not exist in practice in the current LTE system. Such feedback provides the eNB 175 the necessary scheduling flexibility, but comes with several drawbacks. In particular, depending on how the UL feedback is done, the feedback may require multiple UL CSI feedback containers for both rank-1 and rank-2. This type of feedback, depending on the implementation, is very similar to the multi-rank feedback. Exemplary solutions are presented here that are suitable to implement, e.g., this third technique.

Each of the above techniques has its own use case. Preferred rank (e.g., between rank-1 or rank-2) might be provided at the eNB by a single bit per subband. This would result (assuming a 10 MHz system) in an extra feedback of nine bits per report, only for the rank. In addition, a new adaptive rank feedback report would have to be specified in order to capture the frequency selectivity while also the CSI feedback would need to be provided accordingly.

By contrast, we provide herein a feedback scheme reusing the existing 3GPP LTE specification, enabling frequency selective rank feedback. Broadly, one proposal is to reuse an existing rank-2 subband CQI feedback report for adaptive rank reporting.

More specifically, the rank indication(s) may be embedded in the delta CQI reporting of the UE, indicating in this way to the eNB the rank per particular subbands, this information being useful for more efficient SU/MU-MIMO dynamic switching or for frequency selective rank adaptation. Such signaling is used when the UE wants to report feedback with frequency selective rank or when the eNB requests such report type.

The subband rank is indicated as being rank-1 as follows: The delta CQI for one codeword is set as a DISABLED (e.g., NULL/OFF) state.

This implies the following:

i. Rank-1 is preferred by the UE in this particular subband.

ii. Delta CQI of the other codeword is offset level of m MCS classes from an MCS class corresponding to wideband CQI+3 dB. The 3 dB offset comes from LTE Tx power operation, where in rank-2 each layer is transmitted with half power. As is known, the LTE specifications, if a UE 110 reports rank-2 feedback, only a single PMI is reported. The first vector of a codebook entry for the PMI corresponds to the first codeword 0 (zero) and the second (or “other”) vector corresponds to the second codeword 1 (one). This type of feedback is only a UE recommendation to an eNB.

iii. The accompanying PMI corresponds to rank-1 PMI of the other codeword. Alternatively, the accompanying PMI may indicate to use the other vector of rank-2 PMI.

With this exemplary solution, frequency selective rank reporting is enabled in the same CSI feedback container. The subbands on where the rank-1 PMI is reported are pointed by the DISABLED field reported in the delta CQI.

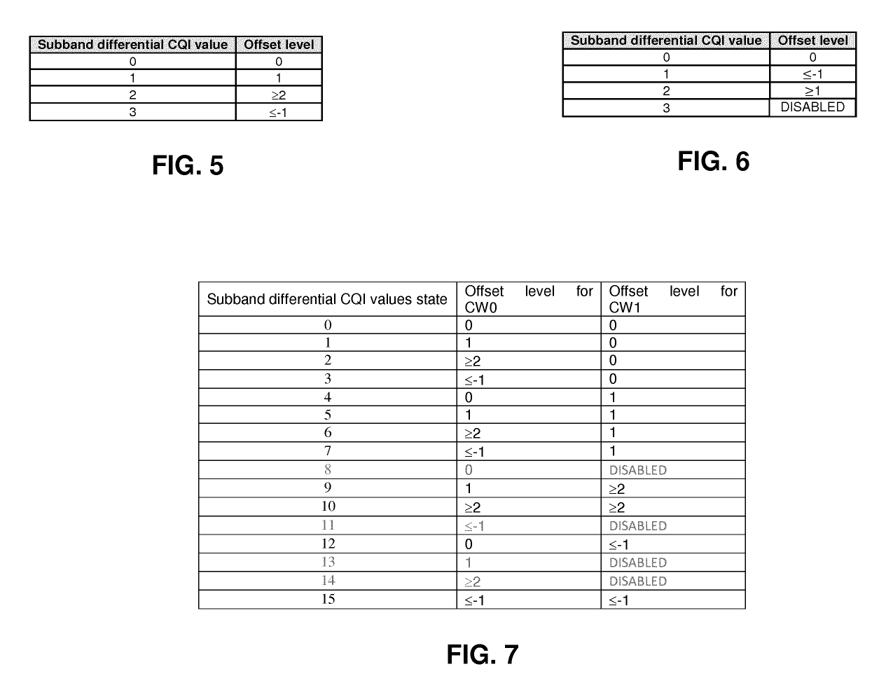

The current frequency selective CQI reporting, according to 3GPP TS 36.213 (e.g., in V12.3.0 (2014-09)), for feedback modes 3-1 and 3-2 is as follows. Per each codeword, a single wideband 4 bit (four bit) CQI and N differential 2 bit (two bit) ACQIs are reported, where N is a number of subbands. The differential ACQIs are reported according to the table shown in FIG. 5. FIG. 5 is a table illustrating 3GPP LTE differential CQI table 7.2.1-2 in 3GPP TS 36.213. Subband CQI value for each codeword is encoded differentially with respect to its respective wideband CQI using 2-bits as defined by the following: Subband differential CQI offset level=subband CQI index−wideband CQI index. The mapping from the 2-bit subband differential CQI value to the offset level is shown in the table in FIG. 5. Thus, offset level, reported per subband, denotes offset in number of MCS classes with respect to an MCS class reported in wideband CQI. One step corresponds roughly to a 2 dB SINR difference. CQI in LTE is reported as an MCS class for which first transmission block-error-rate is approximately 10 percent. Note that in LTE, there are total 16 MCS classes to report CQI, while the eNB can control 32 MCSs, with roughly a 1 dB MCS grid.

According to one or more exemplary embodiments herein, we propose the modification of the above table, as shown in FIG. 6. This figure shows one state is reserved (offset level=DISABLED) to indicate “codeword may be disabled”. The term “disabled” is used by UE 110 to indicate that eNB 170 shall use information (e.g., PMI, CQI), in an example, only for the “other” codeword and transmit rank-1 in that corresponding subband. If the UE disables feedback for one codeword, the eNB has feedback available only for the other codeword. The modification of the table allows the following signaling options as a non-limiting example:

1) ΔCQI₀=ON and ΔCQI₁=ON: rank-2 preferred for this subband;

2) ΔCQI₀=DISABLED and ΔCQI₁=ON: rank-1 preferred for this subband, use a second vector of reported rank-2 PMI;

3) ΔCQI₀=ON and ΔCQI₁=DISABLED: rank-1 preferred for this subband, use a first vector of reported rank-2 PMI; and

4) ΔCQI₀=DISABLED and ΔCQI₁=DISABLED: do not transmit on this subband.

It should be noted, in the above description, the ON state means that one of the ≦−1, 0 or, ≧1 offset is used. Another note is that the ΔCQI₀ (2 bits) and ΔCQI₁ (2 bits) are subband delta CQIs with respect to wideband CQI₀ (4 bits) and CQI₁ (4 bits) corresponding to codeword 0 (zero) and codeword 1 (one), respectively.

In general terms, when the UE 110 is selecting the feedback for the particular subband, the UE may enable/disable both codewords/layers or only one of them, the first one or the other. As described above, disabling of one codeword means that the eNB should transmit only rank-1 in this subband and the eNB should use the wideband CQI+subband delta CQI(n) indicated for the other codeword for subband n for which delta CQI(n) has been reported.

With respect to PMI, each PMI vector corresponds to a layer, on each layer one symbol is transmitted. In other words, a precoding vector spreads one symbol across all transmit antennas. The UE 110 may indicate either rank-2 PMI (e.g., the other vector), or the UE can report rank-1 PMI from a rank-1 codebook. Here what is meant is that each vector of a rank-2 PMI corresponds to one transport-separately-coded-codeword. In LTE, codeword 0 delta-CQI corresponds to the first vector of rank-2 PMI and codeword 1 is transmitted with the second vector of rank-2 PMI. Therefore, if codeword 0 delta-CQI is disabled, then the eNB should use the other (second) vector of the rank-2 PMI for future transmission of the data to the UE. In case of 4Tx, rank-1 and rank-2 codebooks have 16 entries in LTE. In case of 2Tx, rank-2 codebook is only 1 (one) bit, while the rank-1 codebook is 2 (two) bits. In a 2Tx case, clearly, one would prefer feedback of rank-1 PMI (e.g., as there are four options instead of two).

Additionally, if PMI is reported wide-band and CQI is reported subband (e.g., LTE feedback mode 3-1), the typical solution is to report rank-2 PMI. Again, rank-2 PMI has two precoding vectors, on each vector one symbol on each subband is transmitted. Therefore, if the UE 110 wants to disable one codeword, the UE recommends to the eNB to transmit only one symbol per subband, using a precoding vector corresponding to the “other” codeword.

It is to be noted that the four-valued table in FIG. 6 is an LTE example, and the exemplary embodiments herein are not limited to LTE. In general, subband differential CQI table may be 3, 4, . . . bits having 8, 16, . . . values.

The above proposal in FIG. 6, as an example, eliminates option “≧2” for possible CQI subband equalization with respect to wideband CQI, present in FIG. 5. However, note that the FIG. 5 is unbalanced with respect to positive and negative offset, while proposed FIG. 6 becomes balanced. Also note that other offset levels might be replaced by a DISABLED state instead of “≧2”.

A first alternative to minimize the impact of missing option “≧2” would be to use 8 options (3 bits) instead of 4 options (2 bits) per each codeword. The second alternative would be to code both codeword's ΔCQI₀ and ΔCQI₁ jointly, where 4 states out of 16 (2+2 bits) would be reserved to disable codeword (CW) 1. The table in FIG. 7 shows an example of such joint coding. States 8, 11, 13 and 14 indicate rank-1 states while other states correspond to rank-2.

In the example of FIG. 7, we replaced rank-2 states {[0, ≧2], [≦−1, ≧2], [1, ≦−1], [2, ≦−1]} with rank-1 states {[0],[≦−1],[1],[≧2]}. Selection statistics of rank-2 offset-states may identify those rank-2 combinations to be used as rank-1 states. The table in FIG. 7 is only an example. In general, some of the states could be reserved for “disable both codewords” in the particular subband, or disabling the first codeword instead of the second codeword.

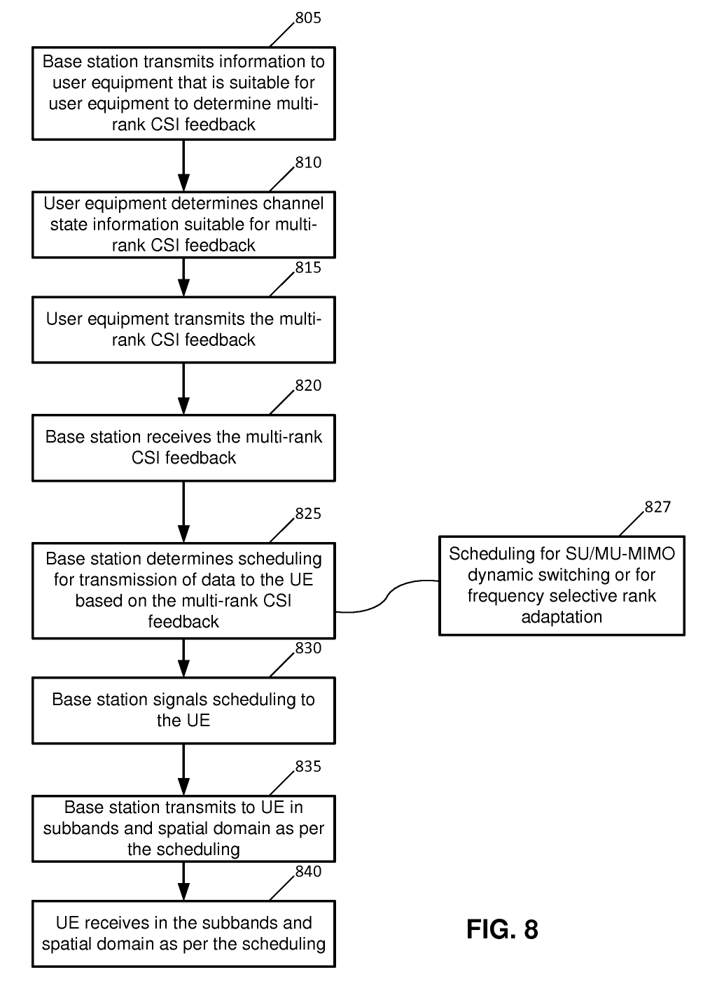

Turning to FIG. 8, a logic flow diagram is shown for efficient multi-rank CSI feedback signaling. FIG. 8 also illustrates the operation of an exemplary method, a result of execution of computer program instructions embodied on a computer readable memory, functions performed by logic implemented in hardware, and/or interconnected means for performing functions in accordance with exemplary embodiments. That is, each of the blocks in FIG. 8 may be considered to be an interconnected means for performing the function in the block. FIG. 8 has blocks for both a base station (e.g., eNB 170, under control in part by the feedback signaling module 150) and a user equipment (e.g., under control in part by the feedback signaling module 140).

In block 805, the base station transmits information to the user equipment that is suitable for the user equipment to determine multi-rank CSI feedback. In block 810, the user equipment (after receiving the information) determines channel state information suitable for multi-rank CSI feedback. Such channel state information has been described above and includes the rank indication that is embedded in the delta CQI reporting of the UE and that can indicate preference for rank-1, rank-2, combinations of these, or no transmission on a subband. In block 815, the user equipment transmits the multi-rank CSI feedback toward the base station. In block 820, the base station receives the multi-rank CSI feedback and in block 825, the base station determines scheduling for transmission of data to the UE based on the multi-rank CSI feedback. Block 827 is an example of block 825, and the multi-rank CSI feedback information is useful for more efficient SU/MU-MIMO dynamic switching or for frequency selective rank adaptation. In block 830, the base station signals the scheduling to the UE, and in block 835 the base station transmits data to the UE in subbands and spatial domain according to scheduling decision made in 825. In block 840, the UE 110 receives data in subbands and spatial domain according to scheduling decision made in 825.

The exemplary embodiments likely have low standardization and implementation impact. One exemplary advantage is that both rank-1 and rank-2 information is contained into a same report, while in addition the PMI/CQI feedback is optimized for each rank per subband.

Such CSI feedback enables also SU/MU dynamic switching where either SU or MU is scheduled over the whole BW, yet is frequency selective. However, one may claim that there is a penalty in scheduling flexibility because, with a compressed CSI report as described herein, the eNB does not have full information over the entire BW for scheduling SU or MU. That is, if the eNB wants to schedule full band MU-MIMO, the eNB needs to make a rank override of subbands reported with rank-2; or if the eNB wants to schedule SU-MIMO rank-2 over the whole band, the eNB would need to somehow guess the rank-2 PMIs and CQIs at the subbands where rank-1 has been reported. Nevertheless, the eNB should not schedule wideband transmissions in the first place, if those are not preferred by the UE. Thus, although the eNB does not have full information over the entire bandwidth for scheduling SU or MU, the frequency selective rank-based CSI reporting is indicating also the dominating rank the eNB should use. Hence, if rank-2 is dominating there is an indication for more SU-MIMO scheduling (and also the possibility for rank override), while if rank-1 CSI is dominating, there is an indication that MU-MIMO could be exploited as rank-2 would have been less beneficial anyway.

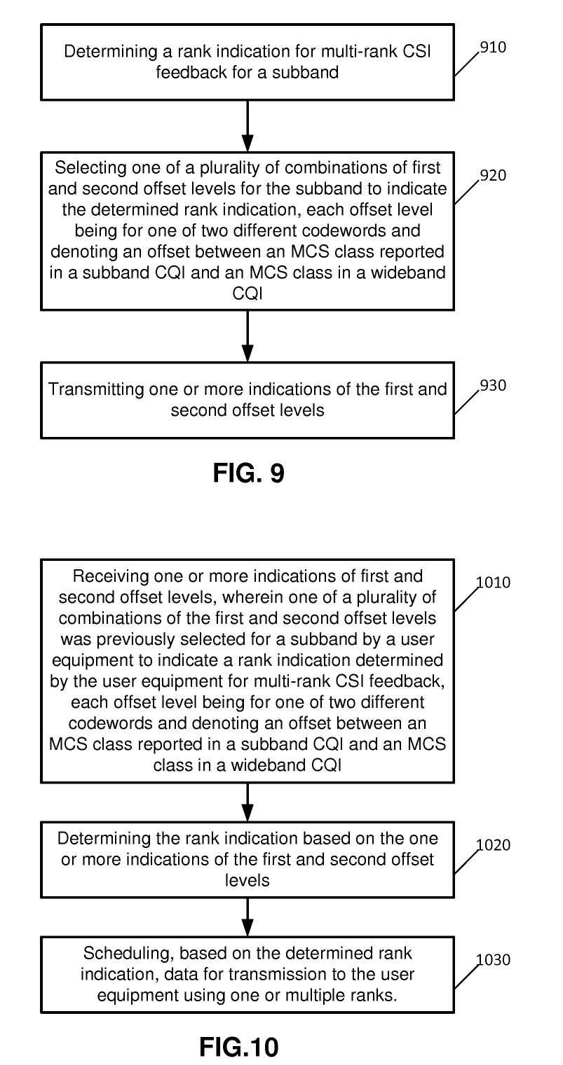

Turning to FIG. 9, a logic flow diagram is shown for efficient multi-rank CSI feedback signaling for a user equipment. FIG. 9 illustrates the operation of an exemplary method, a result of execution of computer program instructions embodied on a computer readable memory, functions performed by logic implemented in hardware, and/or interconnected means for performing functions in accordance with exemplary embodiments. A UE 110 is assumed to perform the blocks in FIG. 9, e.g., under control at least in part of the feedback signaling module 140. The flow in FIG. 9 is also referred to as Example 1 herein.

In block 910, the UE 110 performs the function of determining a rank indication for multi-rank CSI feedback for a subband. In block 920, the UE performs the function of selecting one of a plurality of combinations of first and second offset levels for the subband to indicate the determined rank indication. Each offset level is for one of two different codewords and denotes an offset between an MCS class reported in a subband CQI and an MCS class in a wideband CQI. In block 930, the UE 110 performs the function of transmitting (e.g., toward a base station) one or more indications of the first and second offset levels. Blocks 910 and 920 may be considered to be examples of block 810 in FIG. 8, while block 930 may be considered to be an example of block 815 in FIG. 8.

### Example 2

The method of example 1, wherein individual ones of the combinations of first and second offset levels indicate one of the following: rank-1 is preferred for the subband; rank-2 is preferred for the subband; or do not transmit on the subband.

### Example 3

The method of example 2, wherein the individual ones of the combinations of first and second offset levels indicate one of the following: rank-1 is preferred for the subband, and a second of two vectors of reported rank-2 PMI is to be used; rank-1 is preferred for the subband, and a first of the two vectors of reported rank-2 PMI is to be used; rank-2 is preferred for the subband; or do not transmit on the subband.

### Example 4

The method of example 3, wherein the individual ones of the combinations of first and second offset levels are the following:

1) the combination is ΔCQI₀=ON and ΔCQI₁=ON and this combination indicates that rank-2 is preferred by the user equipment for this subband;

2) the combination is ΔCQI₀=DISABLED and ΔCQI₁=ON and this combination indicates that rank-1 is preferred by the user equipment for this subband, and a second vector of reported rank-2 PMI should be used;

3) the combination is ΔCQI₀=ON and ΔCQI₁=DISABLED and this combination indicates that rank-1 is preferred by the user equipment for this subband, and a first vector of reported rank-2 PMI should be used; and

4) the combination is ΔCQI₀=DISABLED and ΔCQI₁=DISABLED and this combination indicates do not transmit on this subband,

wherein ΔCQI₀ is the first offset level, ΔCQI₁ is the second offset level, and a state of “ON” for an offset level is a level other than a state of DISABLED.

### Example 5

The method of example 4, the state of “ON” corresponds to any offset levels having values of 0, ≦−1, or ≧1.

### Example 6

The method of any of examples 1 to 5, wherein the indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

### Example 7

The method of example 1, wherein each combination of first and second offset levels is determined using jointly coded first and second offset levels, the indication is one of a plurality of states, a first plurality of states for the combinations correspond to a rank indication of rank-2, and a second plurality of states for the combinations correspond to a rank indication of rank-1.

### Example 8

The method of example 8, wherein a jointly coded first and second offset level is determined from the following table:

| Subband | | |
|---|---|---|
| differential | Offset | Offset |
| CQI values | level for | level for |
| state | CW0 | CW1 |
| 0 | 0 | 0 |
| 1 | 1 | 0 |
| 2 | ≧2 | 0 |
| 3 | ≦−1 | 0 |
| 4 | 0 | 1 |
| 5 | 1 | 1 |
| 6 | ≧2 | 1 |
| 7 | ≦−1 | 1 |
| 8 | 0 | DISABLED |
| 9 | 1 | ≧2 |
| 10 | ≧2 | ≧2 |
| 11 | ≦−1 | DISABLED |
| 12 | 0 | ≦−1 |
| 13 | 1 | DISABLED |
| 14 | ≧2 | DISABLED |
| 15 | ≦−1 | ≦−1 |

wherein states 8, 11, 13 and 14 correspond to the rank indication of rank-1, the other states in the table correspond to the rank indication of rank-2, the subband differential CQI values state is the indication of a state, a value of DISABLED indicates the rank indication of rank-1, and CW means codeword.

### Example 9

The method of any of examples 1 to 8, wherein the plurality of combinations reserve a subset of states of the combinations for disabling one of the two different codewords.

Another example is an apparatus comprising: means for determining, at a user equipment, a rank indication for multi-rank CSI feedback for a subband; means for selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and means for transmitting by the user equipment indications of the first and second offset levels. A further example is an apparatus comprising means for performing the method of any of examples 1 to 9. A user equipment can include the apparatus of this paragraph.

An exemplary apparatus includes one or more processors and one or more memories including computer program code. The one or more memories and the computer program code are configured to, with the one or more processors, cause the apparatus to perform the method of any of examples 1 to 9.

Referring to FIG. 10, this figure is a logic flow diagram for efficient multi-rank CSI feedback signaling for a user equipment. FIG. 10 illustrates the operation of an exemplary method, a result of execution of computer program instructions embodied on a computer readable memory, functions performed by logic implemented in hardware, and/or interconnected means for performing functions in accordance with exemplary embodiments. A base station such as eNB 170 is assumed to perform the blocks in FIG. 10, e.g., under control at least in part of the feedback signaling module 150. The flow in FIG. 10 is also referred to as Example 10 herein.

In block 1010, the base station (e.g., eNB 170) performs the function of receiving one or more indications of first and second offset levels, wherein one of a plurality of combinations of the first and second offset levels was previously selected for a subband by a user equipment to indicate a rank indication determined by the user equipment for multi-rank CSI feedback. Each offset level is for one of two different codewords and denotes an offset between an MCS class reported in a subband CQI and an MCS class in a wideband CQI. In block 1020, the base station performs the function of determining the rank indication based on the one or more indications of the first and second offset levels. In block 1030, the base station performs the function of scheduling, based on the determined rank indication, data for transmission to the user equipment using one or multiple ranks. Block 1010 may be considered to be an example of block 830 in FIG. 8, while blocks 1020 and 1030 may be considered to be an example of block 825 in FIG. 8.

### Example 11

The method of example 10, wherein individual ones of the combinations of first and second offset levels indicate one of the following: rank-1 is preferred for the subband; rank-2 is preferred for the subband; or do not transmit on the subband, and wherein scheduling further comprises a corresponding one of the following: scheduling data for transmission to the user equipment on rank-1, if rank-1 is indicated as being preferred for the subband; scheduling data for transmission to the user equipment on rank-2, if rank-2 is indicated as being preferred for the subband; or not scheduling data for transmission to the user equipment for the subband, if do not transmit on the subband is indicated as being preferred for the subband.

### Example 12

The method of example 11, wherein:

the individual ones of the combinations of first and second offset levels indicate one of the following:

rank-1 is preferred for the subband, and a second of two vectors of reported rank-2 PMI is to be used;

rank-1 is preferred for the subband, and a first of the two vectors of reported rank-2 PMI is to be used;

rank-2 is preferred for the subband; or

do not transmit on the subband; and

scheduling further comprises a corresponding one of the following:

scheduling data for transmission to the user equipment on rank-1 and using the second vector of reported rank-2 PMI to transmit for a second one of two codewords while not transmitting to the user equipment on the first one of the two codewords, if rank-1 is indicated as being preferred for the subband, and a second of two vectors of reported rank-2 PMI is to be used;

scheduling data for transmission to the user equipment on rank-1 and using the first vector of reported rank-2 PMI to transmit for a first one of two codewords while not transmitting to the user equipment on the second one of the two codewords, if rank-1 is indicated as being preferred for the subband, and a first of two vectors of reported rank-2 PMI is to be used;

scheduling data for transmission to the user equipment on rank-2, if rank-2 is indicated as being preferred for the subband;

or not scheduling data for transmission to the user equipment for the subband, if do not transmit on the subband is indicated as being preferred for the subband.

### Example 13

The method of example 12, wherein the individual ones of the combinations of first and second offset levels are the following:

1) the combination is ΔCQI₀=ON and ΔCQI₁=ON and this combination indicates that rank-2 is preferred by the user equipment for this subband;

2) the combination is ΔCQI₀=DISABLED and ΔCQI₁=ON and this combination indicates that rank-1 is preferred by the user equipment for this subband, and a second vector of reported rank-2 PMI should be used;

3) the combination is ΔCQI₀=ON and ΔCQI₁=DISABLED and this combination indicates that rank-1 is preferred by the user equipment for this subband, and a first vector of reported rank-2 PMI should be used; and

4) the combination is ΔCQI₀=DISABLED and ΔCQI₁=DISABLED and this combination indicates do not transmit on this subband,

wherein ΔCQI₀ is the first offset level, ΔCQI₁ is the second offset level, and a state of “ON” for an offset level is a level other than a state of DISABLED.

### Example 14

The method of example 13, the state of “ON” corresponds to any offset levels having values of 0, ≦−1, or ≧1.

### Example 15

The method of any of examples 10 to 14, wherein the indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

### Example 16

The method of example 10, wherein each combination of first and second offset levels is determined using jointly coded first and second offset levels, the indication is one of a plurality of states, a first plurality of states for the combinations correspond to a rank indication of rank-2, and a second plurality of states for the combinations correspond to a rank indication of rank-1.

### Example 17

The method of example 16, wherein a jointly coded first and second offset level is determined from the following table:

| Subband | | |
|---|---|---|
| differential | Offset | Offset |
| CQI values | level for | level for |
| state | CW0 | CW1 |
| 0 | 0 | 0 |
| 1 | 1 | 0 |
| 2 | ≧2 | 0 |
| 3 | ≦−1 | 0 |
| 4 | 0 | 1 |
| 5 | 1 | 1 |
| 6 | ≧2 | 1 |
| 7 | ≦−1 | 1 |
| 8 | 0 | DISABLED |
| 9 | 1 | ≧2 |
| 10 | ≧2 | ≧2 |
| 11 | ≦−1 | DISABLED |
| 12 | 0 | ≦−1 |
| 13 | 1 | DISABLED |
| 14 | ≧2 | DISABLED |
| 15 | ≦−1 | ≦−1 |

wherein states 8, 11, 13 and 14 correspond to the rank indication of rank-1, the other states in the table correspond to the rank indication of rank-2, the subband differential CQI values state is the indication of a state, a value of DISABLED indicates the rank indication of rank-1, and CW means codeword.

### Example 18

The method of any of examples 10 to 17, wherein the plurality of combinations reserve a subset of states of the combinations for disabling one of the two different codewords, and wherein scheduling further comprises scheduling data for transmission on the one of the two different codewords that is not disabled and not scheduling data for transmission on the disabled one of the two different codewords.

### Example 19

The method of any of examples 10 to 18, further comprising transmitting the data to user equipment based on the scheduling.

The various controllers/data processors, memories, programs, transceivers and antenna arrays depicted in FIG. 1 may all be considered to represent means for performing operations and functions that implement the several non-limiting aspects and embodiments of this invention.

Another example is an apparatus comprising: means for receiving, at a base station, indication of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; means for determining, by the base station, the rank indication based on the indication of the first and second offset levels; and means for scheduling, based on the determined rank indication and by the base station, data for transmission to the user equipment using one or multiple ranks. A further example is an apparatus comprising means for performing the method of any of examples 10 to 19. A base station can include the apparatus of this paragraph.

An exemplary apparatus includes one or more processors and one or more memories including computer program code. The one or more memories and the computer program code are configured to, with the one or more processors, cause the apparatus to perform the method of any of examples 10 to 19.

An additional exemplary embodiment includes a computer program, comprising code for performing the method of any of claims 1 to 19, when the computer program is run on a processor. The computer program according to this paragraph, wherein the computer program is a computer program product comprising a computer-readable medium bearing computer program code embodied therein for use with a computer.

A system can include any of the apparatus based on methods 1 to 9 and any of the apparatus based on methods 10 to 19.

### Example 20

An apparatus, comprising: means for determining, at a user equipment, a rank indication for multi-rank CSI feedback for a subband; means for selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and means for transmitting by the user equipment one or more indications of the first and second offset levels.

### Example 21

The apparatus of example 20, wherein individual ones of the combinations of first and second offset levels indicate one of the following: rank-1 is preferred for the subband; rank-2 is preferred for the subband; or do not transmit on the subband. Example 22. The apparatus of example 21, wherein the individual ones of the combinations of first and second offset levels indicate one of the following: rank-1 is preferred for the subband, and a second of two vectors of reported rank-2 PMI is to be used; rank-1 is preferred for the subband, and a first of the two vectors of reported rank-2 PMI is to be used; rank-2 is preferred for the subband; or do not transmit on the subband.

### Example 23

The apparatus of example 22, wherein the individual ones of the combinations of first and second offset levels are the following: 1) the combination is ΔCQI₀=ON and ΔCQI₁=ON and this combination indicates that rank-2 is preferred by the user equipment for this subband; 2) the combination is ΔCQI₀=DISABLED and ΔCQI₁=ON and this combination indicates that rank-1 is preferred by the user equipment for this subband, and a second vector of reported rank-2 PMI should be used; 3) the combination is ΔCQI₀=ON and ΔCQI₁=DISABLED and this combination indicates that rank-1 is preferred by the user equipment for this subband, and a first vector of reported rank-2 PMI should be used; and 4) the combination is ΔCQI₀=DISABLED and ΔCQI₁=DISABLED and this combination indicates do not transmit on this subband, wherein ΔCQI₀ is the first offset level, ΔCQI₁ is the second offset level, and a state of “ON” for an offset level is a level other than a state of DISABLED.

### Example 24

The apparatus of example 23, the state of “ON” corresponds to any offset levels having values of 0, ≦−1, or ≧1.

### Example 25

The apparatus of any of examples 20 to 24, wherein an indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

### Example 26

The apparatus of example 20, wherein each combination of first and second offset levels is determined using jointly coded first and second offset levels, the one or more indications is a single indication indicating one of a plurality of states, a first plurality of states for the combinations correspond to a rank indication of rank-2, and a second plurality of states for the combinations correspond to a rank indication of rank-1.

### Example 27

The apparatus of example 26, wherein a jointly coded first and second offset level is determined from the following table:

| Subband | | |
|---|---|---|
| differential | Offset | Offset |
| CQI values | level for | level for |
| state | CW0 | CW1 |
| 0 | 0 | 0 |
| 1 | 1 | 0 |
| 2 | ≧2 | 0 |
| 3 | ≦−1 | 0 |
| 4 | 0 | 1 |
| 5 | 1 | 1 |
| 6 | ≧2 | 1 |
| 7 | ≦−1 | 1 |
| 8 | 0 | DISABLED |
| 9 | 1 | ≧2 |
| 10 | ≧2 | ≧2 |
| 11 | ≦−1 | DISABLED |
| 12 | 0 | ≦−1 |
| 13 | 1 | DISABLED |
| 14 | ≧2 | DISABLED |
| 15 | ≦−1 | ≦−1 |

wherein states 8, 11, 13 and 14 correspond to the rank indication of rank-1, the other states in the table correspond to the rank indication of rank-2, the subband differential CQI values state is the single indication of a corresponding state, a value of DISABLED indicates the rank indication of rank-1, and CW means codeword.

### Example 28

The apparatus of any of examples 20 to 27, wherein the plurality of combinations reserve a subset of states of the combinations for disabling one of the two different codewords. Example 20. A user equipment comprising the apparatus of any of examples 20 to 28.

### Example 30

An apparatus, comprising: means for receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI; means for determining, by the base station, the rank indication based on the one or more indications of the first and second offset levels; and means for scheduling, based on the determined rank indication and by the base station, data for transmission to the user equipment using one or multiple ranks.

### Example 31

The apparatus of example 30, wherein individual ones of the combinations of first and second offset levels indicate one of the following: rank-1 is preferred for the subband; rank-2 is preferred for the subband; or do not transmit on the subband, and wherein scheduling further comprises a corresponding one of the following: scheduling data for transmission to the user equipment on rank-1, if rank-1 is indicated as being preferred for the subband; scheduling data for transmission to the user equipment on rank-2, if rank-2 is indicated as being preferred for the subband; or not scheduling data for transmission to the user equipment for the subband, if do not transmit on the subband is indicated as being preferred for the subband.

### Example 32

The apparatus of example 31, wherein: the individual ones of the combinations of first and second offset levels indicate one of the following: rank-1 is preferred for the subband, and a second of two vectors of reported rank-2 PMI is to be used; rank-1 is preferred for the subband, and a first of the two vectors of reported rank-2 PMI is to be used; rank-2 is preferred for the subband; or do not transmit on the subband; and scheduling further comprises a corresponding one of the following: scheduling data for transmission to the user equipment on rank-1 and using the second vector of reported rank-2 PMI to transmit for a second one of two codewords while not transmitting to the user equipment on the first one of the two codewords, if rank-1 is indicated as being preferred for the subband, and a second of two vectors of reported rank-2 PMI is to be used; scheduling data for transmission to the user equipment on rank-1 and using the first vector of reported rank-2 PMI to transmit for a first one of two codewords while not transmitting to the user equipment on the second one of the two codewords, if rank-1 is indicated as being preferred for the subband, and a first of two vectors of reported rank-2 PMI is to be used; scheduling data for transmission to the user equipment on rank-2, if rank-2 is indicated as being preferred for the subband; or not scheduling data for transmission to the user equipment for the subband, if do not transmit on the subband is indicated as being preferred for the subband.

### Example 33

The apparatus of example 32, wherein the individual ones of the combinations of first and second offset levels are the following: 1) the combination is ΔCQI₀=ON and ΔCQI₁=ON and this combination indicates that rank-2 is preferred by the user equipment for this subband; 2) the combination is ΔCQI₀=DISABLED and ΔCQI₁=ON and this combination indicates that rank-1 is preferred by the user equipment for this subband, and a second vector of reported rank-2 PMI should be used; 3) the combination is ΔCQI₀=ON and ΔCQI₁=DISABLED and this combination indicates that rank-1 is preferred by the user equipment for this subband, and a first vector of reported rank-2 PMI should be used; and 4) the combination is ΔCQI₀=DISABLED and ΔCQI₁=DISABLED and this combination indicates do not transmit on this subband, wherein ΔCQI₀ is the first offset level, ΔCQI₁ is the second offset level, and a state of “ON” for an offset level is a level other than a state of DISABLED.

### Example 34

The apparatus of example 33, the state of “ON” corresponds to any offset levels having values of 0, ≦−1, or ≧1.

### Example 35

The apparatus of any of examples 30 to 34, wherein an indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

### Example 36

The apparatus of example 30, wherein each combination of first and second offset levels is determined using jointly coded first and second offset levels, the one or more indications is a single indication indicating one of a plurality of states, a first plurality of states for the combinations correspond to a rank indication of rank-2, and a second plurality of states for the combinations correspond to a rank indication of rank-1.

### Example 37

The apparatus of example 36, wherein a jointly coded first and second offset level is determined from the following table:

| Subband | | |
|---|---|---|
| differential | Offset | Offset |
| CQI values | level for | level for |
| state | CW0 | CW1 |
| 0 | 0 | 0 |
| 1 | 1 | 0 |
| 2 | ≧2 | 0 |
| 3 | ≦−1 | 0 |
| 4 | 0 | 1 |
| 5 | 1 | 1 |
| 6 | ≧2 | 1 |
| 7 | ≦−1 | 1 |
| 8 | 0 | DISABLED |
| 9 | 1 | ≧2 |
| 10 | ≧2 | ≧2 |
| 11 | ≦−1 | DISABLED |
| 12 | 0 | ≦−1 |
| 13 | 1 | DISABLED |
| 14 | ≧2 | DISABLED |
| 15 | ≦−1 | ≦−1 |

wherein states 8, 11, 13 and 14 correspond to the rank indication of rank-1, the other states in the table correspond to the rank indication of rank-2, the subband differential CQI values state is the single indication of a corresponding state, a value of DISABLED indicates the rank indication of rank-1, and CW means codeword.

### Example 38

The apparatus of any of examples 30 to 37, wherein the plurality of combinations reserve a subset of states of the combinations for disabling one of the two different codewords, and wherein scheduling further comprises scheduling data for transmission on the one of the two different codewords that is not disabled and not scheduling data for transmission on the disabled one of the two different codewords.

### Example 39

The apparatus of any of examples 30 to 38, further comprising transmitting the data to user equipment based on the scheduling.

### Example 40

A base station comprising the apparatus of any of examples 30 to 39.

### Example 41

A system comprising an apparatus according to any of examples 20 to 28 and an apparatus according to any of examples 30 to 39.

Without in any way limiting the scope, interpretation, or application of the examples appearing below, a technical effect of one or more of the example embodiments disclosed herein is how to efficiently (e.g., with low overhead) report frequency selective CSI (e.g., rank, PMI, CQI) feedback, while minimizing the impact on a standard, i.e., minimizing standardization and implementation effort. Another technical effect of one or more of the example embodiments disclosed herein is to report frequency selective CSI (e.g., rank, PMI, CQI) feedback.

Embodiments of the present invention may be implemented in software, hardware, application logic or a combination of software, hardware and application logic. A computer-readable medium may comprise a computer-readable storage medium that may be any media or means that can contain or store the instructions for use by or in connection with an instruction execution system, apparatus, or device, such as a computer. A computer-readable storage medium does not encompass propagating signals.

If desired, the different functions discussed herein may be performed in a different order and/or concurrently with each other. Furthermore, if desired, one or more of the above-described functions may be optional or may be combined. Although various aspects of the invention are set out above, other aspects of the invention comprise other combinations of features from the described embodiments with the features of other described embodiments, and not solely the combinations explicitly set out above.

It is also noted herein that while the above describes example embodiments of the invention, these descriptions should not be viewed in a limiting sense. Rather, there are several variations and modifications which may be made without departing from the scope of the various inventions described herein.

The following abbreviations that may be found in the specification and/or the drawing figures are defined as follows:
3GPP Third generation partnership project
BW Bandwidth
CSI Channel State Information
CQI Channel Quality Indicator
CRC Cyclic Redundancy Check
CW codeword
dB decibels
DL Downlink, from base station to UE
eNB evolved NodeB, e.g., an LTE base station
LTE Long Term Evolution
MAC Medium Access Layer
MCS Modulation and Coding Scheme
MHz mega-Hertz
MIMO Multiple Input Multiple Output
MU Multi-User
MU-IC Multi-user interference cancellation
NAICS Network-Assisted Interference Cancellation and Suppression
nSCID Scrambling Identity
PMI Precoding Matrix Indicator
PUSCH Physical Uplink Shared Channel
RAN Radio Access Network
Rel Release
RI Rank Index
SU Single-User
TB Transport Block
TTI Transmission Time Interval
Tx transmission or transmitter
UE User equipment (e.g., wireless, portable device)
UL Uplink, from UE to base station

1. A method comprising:
determining, at a user equipment, a rank indication for multi-rank CSI feedback for a subband;
selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and
transmitting by the user equipment one or more indications of the first and second offset levels.

2. The method of claim 1, wherein individual ones of the combinations of first and second offset levels indicate one of the following: rank-1 is preferred for the subband; rank-2 is preferred for the subband; or do not transmit on the subband.

3. The method of claim 2, wherein the individual ones of the combinations of first and second offset levels indicate one of the following: rank-1 is preferred for the subband, and a second of two vectors of reported rank-2 PMI is to be used; rank-1 is preferred for the subband, and a first of the two vectors of reported rank-2 PMI is to be used; rank-2 is preferred for the subband; or do not transmit on the subband.

4. The method of claim 3, wherein the individual ones of the combinations of first and second offset levels are the following:
1) the combination is ΔCQI₀=ON and ΔCQI₁=ON and this combination indicates that rank-2 is preferred by the user equipment for this subband;
2) the combination is ΔCQI₀=DISABLED and ΔCQI₁=ON and this combination indicates that rank-1 is preferred by the user equipment for this subband, and a second vector of reported rank-2 PMI should be used;
3) the combination is ΔCQI₀=ON and ΔCQI₁=DISABLED and this combination indicates that rank-1 is preferred by the user equipment for this subband, and a first vector of reported rank-2 PMI should be used; and
4) the combination is ΔCQI₀=DISABLED and ΔCQI₁=DISABLED and this combination indicates do not transmit on this subband,
wherein ΔCQI₀ is the first offset level, ΔCQI₁ is the second offset level, and a state of “ON” for an offset level is a level other than a state of DISABLED.

5. The method of claim 4, the state of “ON′ corresponds to any offset levels having values of 0, ≦−1, or ≧1.

6. The method of claim 1, wherein an indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

7. The method of claim 1, wherein each combination of first and second offset levels is determined using jointly coded first and second offset levels, the one or more indications is a single indication indicating one of a plurality of states, a first plurality of states for the combinations correspond to a rank indication of rank-2, and a second plurality of states for the combinations correspond to a rank indication of rank-1.

8. The method of claim 7, wherein a jointly coded first and second offset level is determined from the following table:

| Subband | | |
|---|---|---|
| differential CQI | Offset level | Offset level |
| values state | for CW0 | for CW1 |
| 0 | 0 | 0 |
| 1 | 1 | 0 |
| 2 | ≧2 | 0 |
| 3 | ≦−1 | 0 |
| 4 | 0 | 1 |
| 5 | 1 | 1 |
| 6 | ≧2 | 1 |
| 7 | ≦−1 | 1 |
| 8 | 0 | DISABLED |
| 9 | 1 | ≧2 |
| 10 | ≧2 | ≧2 |
| 11 | ≦−1 | DISABLED |
| 12 | 0 | ≦−1 |
| 13 | 1 | DISABLED |
| 14 | ≧2 | DISABLED |
| 15 | ≦−1 | ≦−1 |

wherein states 8, 11, 13 and 14 correspond to the rank indication of rank-1, the other states in the table correspond to the rank indication of rank-2, the subband differential CQI values state is the single indication of a corresponding state, a value of DISABLED indicates the rank indication of rank-1, and CW means codeword.

9. The method of claim 1, wherein the plurality of combinations reserve a subset of states of the combinations for disabling one of the two different codewords.

10. (canceled)

11. (canceled)

12. A method, comprising:
receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an
offset between an MCS class reported in a subband CQI and an MCS class in a wideband CQI;
determining, by the base station, the rank indication based on the one or more indications of the first and second offset levels; and
scheduling, based on the determined rank indication and by the base station, data for transmission to the user equipment using one or multiple ranks.

13. The method of claim 12, wherein individual ones of the combinations of first and second offset levels indicate one of the following: rank-1 is preferred for the subband; rank-2 is preferred for the subband; or do not transmit on the subband, and wherein scheduling further comprises a corresponding one of the following: scheduling data for transmission to the user equipment on rank-1, if rank-1 is indicated as being preferred for the subband; scheduling data for transmission to the user equipment on rank-2, if rank-2 is indicated as being preferred for the subband; or not scheduling data for transmission to the user equipment for the subband, if do not transmit on the subband is indicated as being preferred for the subband.

14. The method of claim 13, wherein:
the individual ones of the combinations of first and second offset levels indicate one of the following:
rank-1 is preferred for the subband, and a second of two vectors of reported rank-2 PMI is to be used;
rank-1 is preferred for the subband, and a first of the two vectors of reported rank-2 PMI is to be used;
rank-2 is preferred for the subband; or
do not transmit on the subband; and
scheduling further comprises a corresponding one of the following:
scheduling data for transmission to the user equipment on rank-1 and using the second vector of reported rank-2 PMI to transmit for a second one of two codewords while not transmitting to the user equipment on the first one of the two codewords, if rank-1 is indicated as being preferred for the subband, and a second of two vectors of reported rank-2 PMI is to be used;
scheduling data for transmission to the user equipment on rank-1 and using the first vector of reported rank-2 PMI to transmit for a first one of two codewords while not transmitting to the user equipment on the second one of the two codewords, if rank-1 is indicated as being preferred for the subband, and a first of two vectors of reported rank-2 PMI is to be used;
scheduling data for transmission to the user equipment on rank-2, if rank-2 is indicated as being preferred for the subband; or not scheduling data for transmission to the user equipment for the subband, if do not transmit on the subband is indicated as being preferred for the subband.

15. The method of claim 14, wherein the individual ones of the combinations of first and second offset levels are the following:
1) the combination is ΔCQI₀=ON and ΔCQI₁=ON and this combination indicates that rank-2 is preferred by the user equipment for this subband;
2) the combination is ΔCQI₀=DISABLED and ΔCQI₁=ON and this combination indicates that rank-1 is preferred by the user equipment for this subband, and a second vector of reported rank-2 PMI should be used;
3) the combination is ΔCQI₀=ON and ΔCQI₁=DISABLED and this combination indicates that rank-1 is preferred by the user equipment for this subband, and a first vector of reported rank-2 PMI should be used; and
4) the combination is ΔCQI₀=DISABLED and ACQ̂=DISABLED and this combination indicates do not transmit on this subband,
wherein ΔCQI₀ is the first offset level, ACQ̂ is the second offset level, and a state of “ON′ for an offset level is a level other than a state of DISABLED.

16. The method of claim 15, the state of “ON′ corresponds to any offset levels having values of 0, ≦−1, or ≧1.

17. The method of claim 12, wherein an indication of an offset level is determined by the following table:

| Subband | |
|---|---|
| differential | Offset |
| CQI value | level |
| 0 | 0 |
| 1 | ≦−1 |
| 2 | ≧1 |
| 3 | DISABLED |

wherein the subband differential CQI value is the indication of a corresponding offset level.

18. The method of claim 12, wherein each combination of first and second offset levels is determined using jointly coded first and second offset levels, the one or more indications is a single indication indicating one of a plurality of states, a first plurality of states for the combinations correspond to a rank indication of rank-2, and a second plurality of states for the combinations correspond to a rank indication of rank-1.

19. The method of claim 18, wherein a jointly coded first and second offset level is determined from the following table:

| Subband | | |
|---|---|---|
| differential | Offset | Offsel |
| CQI | level | level |
| values state | for CW0 | for CW1 |
| 0 | 0 | 0 |
| 1 | 1 | 0 |
| 2 | ≧2 | 0 |
| 3 | ≦1 | 0 |
| 4 | 0 | 1 |
| 5 | 1 | 1 |
| 6 | ≧2 | 1 |
| 7 | ≦1 | 1 |
| 8 | 0 | DISABLED |
| 9 | 1 | ≧2 |
| 10 | ≧2 | ≧2 |
| 11 | ≦1 | DISABLED |
| 12 | 0 | ≦1 |
| 13 | 1 | DISABLED |
| 14 | ≧2 | DISABLED |
| 15 | ≦1 | ≦1 |

wherein states 8, 11, 13 and 14 correspond to the rank indication of rank-1, the other states in the table correspond to the rank indication of rank-2, the subband differential CQI values state is the single indication of a corresponding state, a value of DISABLED indicates the rank indication of rank-1, and CW means codeword.

20. The method of claim 12, wherein the plurality of combinations reserve a subset of states of the combinations for disabling one of the two different codewords, and wherein scheduling further comprises scheduling data for transmission on the one of the two different codewords that is not disabled and not scheduling data for transmission on the disabled one of the two different codewords.

21. The method of claim 12, further comprising transmitting the data to user equipment based on the scheduling.

22. (canceled)

23. (canceled)

24. An apparatus, comprising:
one or more processors, and
one or more memories including computer program code, the one or more memories and the computer program code are configured to, with the one or more processors, cause the apparatus to perform operations comprising:
determining, at a user equipment, a rank indication for multi-rank CSI feedback for a subband;
selecting, at the user equipment, one of a plurality of combinations of first and second offset levels for the subband to indicate the determined rank indication, each offset level being for one of two different codewords and denoting an offset between an MCS class reported in a subband CQI and an MCS class in a wideband CQI; and
transmitting by the user equipment one or more indications of the first and second offset levels.

25. An apparatus, comprising:
one or more processors, and
one or more memories including computer program code, the one or more memories and the computer program code are configured to, with the one or more processors, cause the apparatus to perform operations comprising:
receiving, at a base station, one or more indications of first and second offset levels, wherein one of a plurality of combinations of the first and second offset levels was previously selected for a subband by a user equipment to indicate a rank indication determined by the user equipment for multi-rank CSI feedback, each offset level being for one of two different codewords and denoting an offset between an MCS class reported in a subband CQI and an MCS class in a wideband CQI;
determining, by the base station, the rank indication based on the one or more indications of the first and second offset levels; and
scheduling, based on the determined rank indication and by the base station, data for transmission to the user equipment using one or multiple ranks.
